(19) United States
(12) Patent Application Publication
(10) Pub. No.: US 2003/0178007 A1
(43) Pub. Date: Sep. 25, 2003

(54) Fuel line cooler

(76) Inventor: Wendy Rae McCarville, Garden City, NY (US)

Correspondence Address: John L. Welsh, Suite 112, 2341 Jefferson Davis Hwy., Arlington, VA, 22202, US

(21) Appl. No.: 10/390,793

(22) Filed: Mar. 19, 2003

Related U.S. Application Data
(60) Provisional application No. 60/365,174, filed on Mar. 19, 2002.

(51) Int. Cl. F02M 15/00

(52) U.S. Cl. 123/541

(57) ABSTRACT

A fuel line cooling device and method of use including a bag with a pair of pockets separated by a fold line, a frozen material contained within the pockets, a waterproof material separating the frozen material from the bag and wherein the bag includes straps for securing it to itself while wrapped around a fuel line. The method of cooling a fuel line of a vehicle having the following steps (a) placing frozen material enclosed within a waterproof receptacle into a bag; (b) sealing the bag closed; (c) wrapping the bag containing the frozen material around the fuel line and securing it to itself; (d) permitting the bag to remain in contact with the fuel line for a length of time; and (e) removing the bag from the fuel line.

### CROSS REFERENCE TO RELATED APPLICATIONS

This application is based upon provisional application No. 60/365,174 filed on Mar. 19, 2002.

### BACKGROUND OF THE INVENTION

1. Field of the Invention

The invention relates to a device for cooling the fuel line and thus the fuel consumed by race cars. More particularly, the invention relates to a cooling device which wraps around a fuel line in drag race vehicles for increasing the effective horsepower obtained from an internal combustion engine.

2. Description of the Prior Art

Many attempts have been made to cool fuel systems in motor vehicles so as to increase the performance of the vehicles. For example, see U.S. Pat. No. 5,251,603 to Watanabe et al., U.S. Pat. No. 6,041,763 to Akyildiz, U.S. Pat. No. 6,250,328 to Distelhoff et al. and U.S. Pat. No. 6,269,804 to Braun et al. Watanabe et al. disclose a vehicle's air conditioning system used to cool a fuel line. Akyildiz discloses magnets and a heat exchanger cooperating with a fuel line. Distelhoff et al. locate the return fuel line in a ventilation cooling duct, while Braun et al. use a liquid coolant to cool a fuel rail.

While a wide variety of cooling devices and systems have been developed, a need continues to exist for a unique low cost method of cooling the engines of drag racing vehicles between and during races to aid in obtaining greater or consistent performance during the course of a racing event. The present invention provides such a device.

### SUMMARY OF THE INVENTION

It is, therefore, an object of the present invention to provide a device for cooling the fuel line before the throttle, fuel injection system or carburetor of an engine. The device includes a fire resistant wrap with pockets for holding a frozen material, such as an ice pack, gel pak, or ice.

It is another object of the present invention to provide a wrap with a fold line wherein the fuel line rests in the fold line when the device is secured thereabout.

It is also an object of the present invention to provide a device wherein the wrap is a fireproof fabric bag with hook and loop resealable straps.

It is another object of the present invention to provide bags of varying shapes and sizes to cover different length fuel lines.

It is a further object of the present invention to provide a device wherein the ice pack or gel type pack is re-freezable after initial use.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a top plan view of the present invention.

FIG. 2 is bottom plan view of the present invention.

FIG. 3 is a side view of the present invention shown wrapped about a fuel line.

FIG. 4 is a cross sectional view along line 3-3 of FIG. 3.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limited, but merely as the basis for the claims and as a basis for teaching one skilled in the art how to make and/or use the invention.

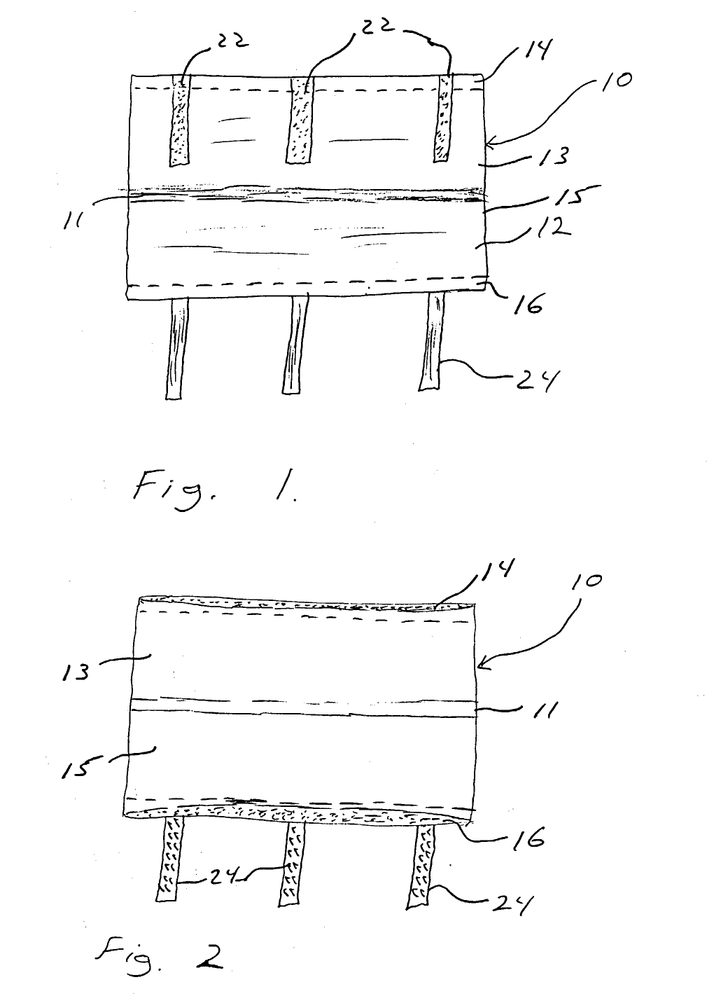

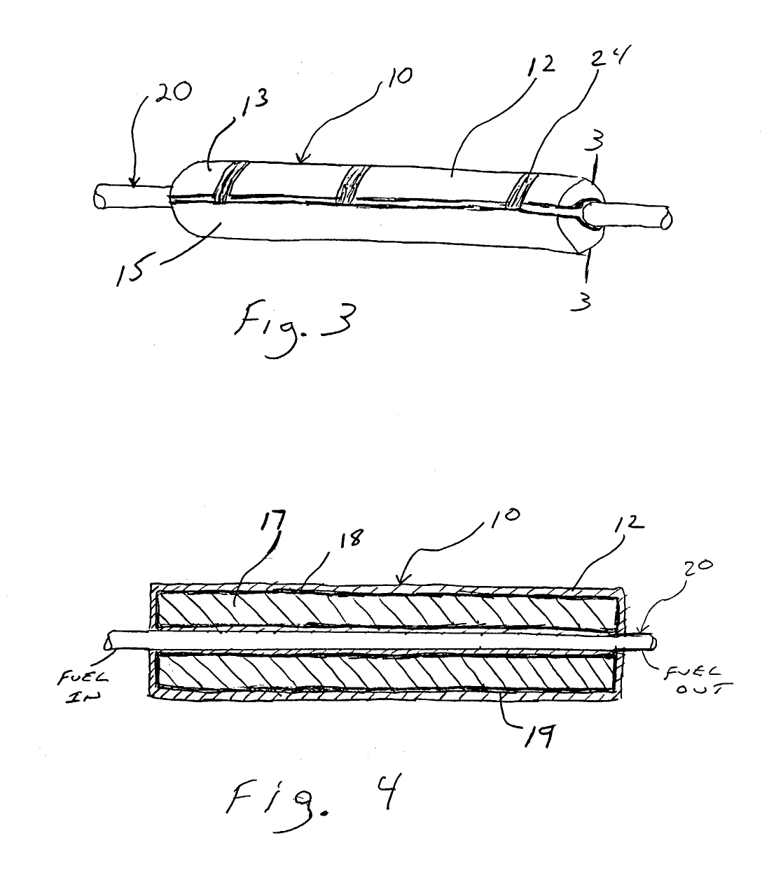

With reference to FIGS. 1-4, the fuel line cooling device 10 in accordance with the present invention is shown in cooperation with a fuel line 20. With reference to FIGS. 1 and 2, the cooling device 10 includes an outer bag 12 made from a canvas material. The outer bag 12 is treated with flame or heat retardant chemicals to make the bag 12 fire resistant or proof. “Fireproof” as used herein is intended to indicate that the material will not burn when in contact with a surface 150 degrees Fahrenheit and higher for prolonged time periods. Various conventional flame retardant materials are well known, such as those disclosed in U.S. Pat. No. 4,898,757 to Maix.

It is contemplated, however, that the outer bag could be made from various materials so long as they are flexible and permit the bag to come into contact with a surface of the fuel line 20. In addition, such materials need not be fireproof.

Bag 12 is formed of two pockets 13 and 15 with a fold line 11 located therebetween. At the opening of each pocket is a resealable closure 14, 16, respectively. The closures are preferably of the hook and loop type, which permit repeated access to the inside of the pockets. Each closure is located on opposing ends of the bag 12. Enclosed within each pocket 13 and 15 is a removable frozen pack 17 contained within a removable waterproof receptacle 18. It is also contemplated that the inside of bag 12 could be lined or coated with a water resistant material 19. The frozen material 17 may be ice, a re-freezable gel pack, or a one-time use, break to activate ice pak. The frozen material 17 is best shown in FIG. 4.

Located on the outer surface of bag 12 are securing straps 22 preferably of the loop type which cooperate with straps 24 of the hook type. Straps 24 are positioned to align with straps 22 and extend from the bag 12 at closure 16.

Fold line 11 permits the bag 12 to wrap about fuel line 20 such that a larger portion of pockets 13 and 15 can come into contact with the surface of fuel line 20.

In use, a frozen pack 17 is inserted into each pocket 13 and 15 and the closures 14 and 16 are sealed. The bag 12 is then positioned about a length of fuel line 20 such that the fuel line resides in fold line 11. The bag 12 is then wrapped around fuel line 20 and secured to itself by straps 22 and 24. The cooling device 10 now encompasses and cools the fuel line and in turn the fuel running through the line before it enters the throttle, fuel injection system or carburetor of an engine to improve the operation thereof. Specifically, due to the cooling of the fuel the air fuel ratio is adjusted and results in increase performance or horsepower. The bag 12 can be removed from the fuel line prior to the vehicle drag racing and still provide residual cooling due to the heat transfer between the fuel line and the pockets containing the frozen packs 17 or, due to the secure attachment via straps 22 and 24, the bag 12 can be left wrapped about the fuel line during a drag race. Once the frozen packs have warmed up too much, they may be replaced with other frozen packs.

While the preferred embodiments have been shown and described, it will be understood that there is no intent to limit the invention by such disclosure, but rather, is intended to cover all modifications and alternate constructions falling within the spirit and scope of the invention as defined in the appended claims.

1. A fuel line cooling device comprising a bag with a pair of pockets separated by a fold line, a frozen material contained within the pockets, a waterproof material separating the frozen material from the bag and wherein the bag includes straps for securing it to itself while wrapped around a fuel line.

2. The cooling device according to claim 1, wherein the frozen material is contained within a waterproof receptacle.

3. The cooling device according to claim 1, wherein the frozen material is ice.

4. The cooling device according to claim 1, wherein the frozen material is a reusable gel pak.

5. The cooling device according to claim 1, wherein the outer surface of the bag is treated so as to be fire resistant.

6. The cooling device according to claim 1, wherein the bag includes a resealable opening at the opening of each pocket permitting removal and replacement of the frozen material.

7. A method of cooling a fuel line of a vehicle comprising the steps of:
(a) placing frozen material enclosed within a waterproof receptacle into a bag;
(b) sealing the bag closed;
(c) wrapping the bag containing the frozen material around the fuel line and securing it to itself;
(d) permitting the bag to remain in contact with the fuel line for a length of time; and
(e) removing the bag from the fuel line.
